(19) United States
(12) Patent Application Publication
(10) Pub. No.: US 2009/0191727 A1
(43) Pub. Date: Jul. 30, 2009

(54) Electrical connector having improved terminal module

(75) Inventor: Feng Pan, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/322,195

(22) Filed: Jan. 29, 2009

(30) Foreign Application Priority Data
Jan. 29, 2008 (CN) 200820031810.3

(51) Int. Cl. H01R 12/00

(52) U.S. Cl. 439/76.1

(57) ABSTRACT

An electrical connector (100) has an insulative housing (1), a number of terminal modules (2) mounted to the insulative housing. The terminal module has a base (22) defining a recess portion (225) thereon on a side surface (223) thereof, a number of terminals (21) assembled to the one surface of the base and a shielding plate (24) mounted to another side surface of the base. The terminal has an intermediate portion (213) received in the recess portion. The electrical connector further has a cover (23) mounted to the recess portion and having a floor (233) cooperating with the recess portion to fix the intermediate portion of the terminals within the recess portion, and a tongue section (232) extending from the floor for retaining the terminals.

### BACKGROUND OF THE INVENTION

1. Field of the Invention

The present invention relates to an electrical connector, and more particularly to an electrical connector having a plurality of improved terminal modules.

2. Description of the Prior Art

U.S. Pat. No. 6,899,566 issued on May 31, 2005, discloses an electrical connector for mounting to a mother board. The electrical connector has an insulative housing, a plurality of terminal modules mounted to the insulative housing. The terminal module has a base, a group of terminals provided with two tails exposed from the base, a cover attached to a header portion of the base and defining a plurality of passageways for fixing one tail of the terminal, a shielding plate mounted to another surface of the base and having a plurality of tines exposed from the base. Therefore, during assembly, the terminals could not be firmly fixed to the base via the engagement between the cover and the header portion of the base, and it is easy to cause instability and damage of the terminals of the terminal module.

Hence, an improved electrical connector is needed to solve the above problem.

### BRIEF SUMMARY OF THE INVENTION

One object of the present invention is to provide an electrical connector comprising a terminal module having an improved cover firmly fixing the terminals.

The present invention provides an electrical connector comprising an insulative housing comprising a plurality of passageways, a plurality of terminal modules mounted to the insulative housing. The terminal module comprises a base defining a recess portion on a side face thereof, a shielding plate mounted to another side surface of the base, a plurality of terminals assembled to the base and a cover assembled with the base and sandwiching therebetween the terminals. The terminals respectively comprises a contacting portion exposed from a forward edge of the base, a tail exposed from a bottom edge of the base for connecting to the printed circuit board, and an intermediate portion connecting the contacting portion and the tail. The cover comprises a floor covering a least the intermediate portion of the terminals, and a tongue section extending from the floor and defining a plurality of terminal spaces for receiving the contacting portions of the terminals.

Advantages of the present invention are to provide a cover having a floor shaped to position the intermediate terminals to the recess portion as so to firmly fix the terminals to the base and avoid instability of the terminals.

Other objects, advantages and novel features of the invention will become more apparent from the following detailed description of the present embodiments when taken in conjunction with the accompanying drawings.

### BRIEF DESCRIPTION OF THE DRAWINGS

FIG. 1 is an assembled perspective view of an electrical connector, in accordance with a first embodiment of the present invention;

FIG. 2 is a partially exploded view of the electrical connector as shown in FIG. 1;

FIG. 3 is an exploded view of a terminal module;

FIG. 4 is another exploded view of the terminal module, taken from another aspect;

FIG. 5 is an assembled perspective view of an electrical connector in accordance with a second embodiment;

FIG. 6 is a partially exploded view of the electrical connector as shown in FIG. 5;

FIG. 7 is an exploded view of a terminal module s shown in FIG. 5; and

FIG. 8 is another exploded view of the terminal module s shown in FIG. 5, taken from another aspect.

### DETAILED DESCRIPTION OF THE INVENTION

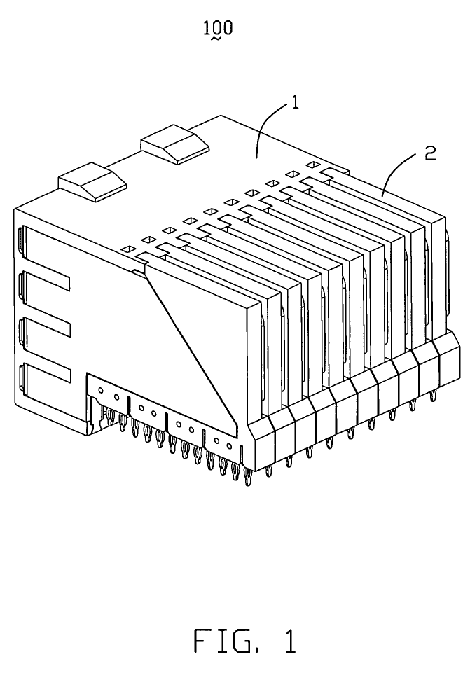

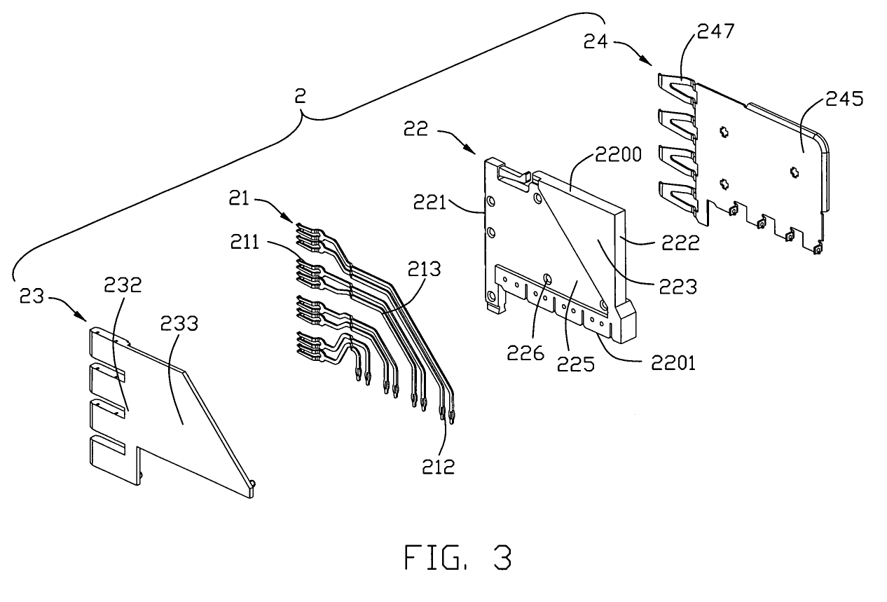

Reference will now be made to the drawing figures to describe the pre-sent invention in detail. Referring to FIGS. 1-4, an electrical connector 1 for mounting on a printed circuit board (not shown) comprises an insulative housing 1 and a plurality of terminal modules 2 mounted to the insulative housing 1.

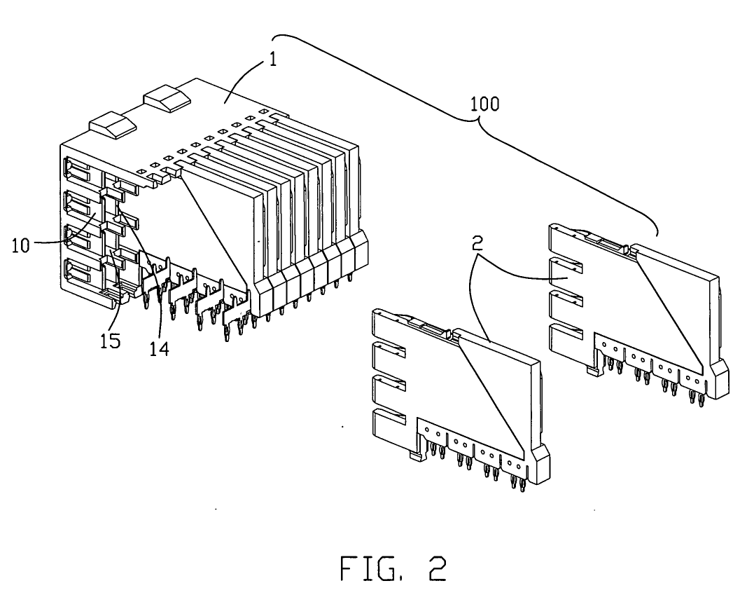

Referring to FIGS. 1 and 2, the insulative housing 1 has a front wall (not labeled), a rear wall 14, four groups of passageways 15 profiled one above the other and extending through the rear wall 14 and front wall.

Referring to FIGS. 1-4, the terminal module 2 comprises a base 22 having a first surface 223 and a second surface 224 opposite to the first surface 223, a plurality of terminals 21 mounted to the passageways 15 of the insulative housing 1 and a shielding plate 23 assembled to the second surface 224 of the base 22. The first surface 223 has a recess portion 225 defined thereon for engaging with the terminals 21. The base 22 is of rectangular configuration and has a top face 2200, a bottom face 2201 and a pair of side faces 221, 222.

The plurality of terminals 21 assembled to the base 22 during injecting molding. Each terminal 21 comprises a contacting portion 211 exposed from a first side face 211 of the base 22, a tail 212 exposed from the bottom face 2201 of the base 22 and connected to the printed circuit board, and an intermediate portion 213 connecting the contacting portion 211 and the tail 212 and received in the recess portion 225.

The terminal module 2 further comprises a cover 23 mounted to the recess portion 225 of the base 22. The cover 23 comprises a floor 233 cooperating with the recess portion 225 to fix the intermediate portions 213 of terminals 21 within the recess portion 225, and a tongue section 232 extending from the floor 233. The tongue section 232 comprises a plurality blades 2320 protruding therefrom to form a plurality of terminal spaces 231 between two adjacent blades 2320 for retaining the contacting portions 221 of the terminals 22. The cover 23 has a plurality of posts 234, 235 formed on the floor 233. The base 22 comprises corresponding holes 226 defined thereon for engaging with the posts 234, 235 of the floor 233.

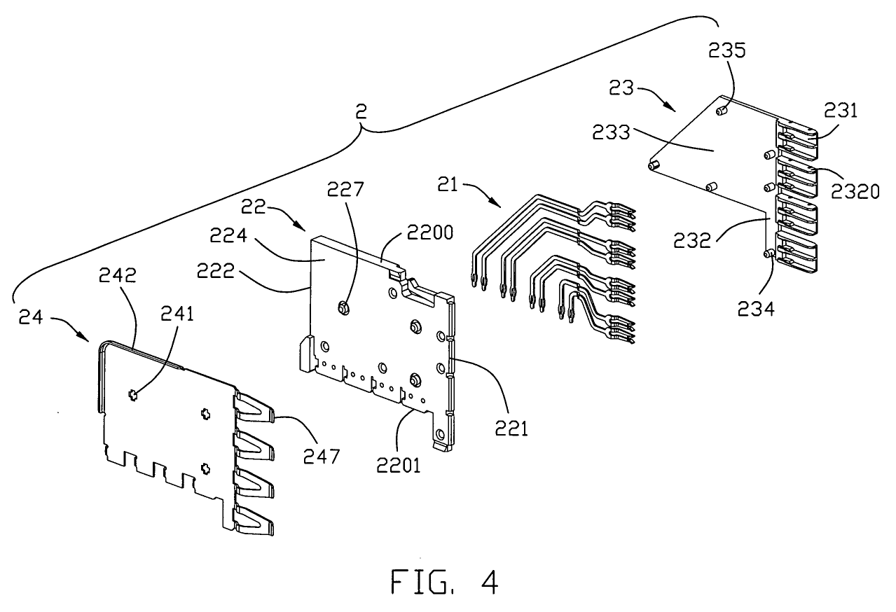

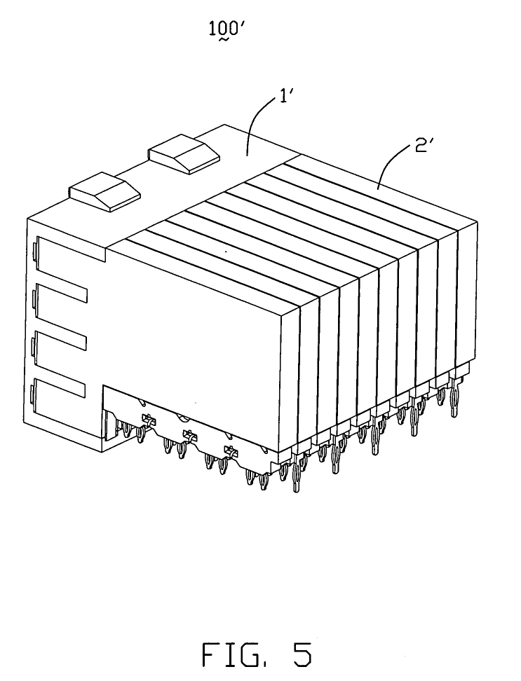

Referring to FIGS. 4 and 5, the shielding plate 24 is punched by a metal strip and has a intermediate plate 245 and a plurality of grounding contacts 247 extending from the intermediate plate 245 and exposed from the first side face 221 of the base 22. The grounding contact 247 has a V-shape and inserts to the passageway 15 of the insulative housing 1. The intermediate plat 245 comprises a plurality of cross-shaped cavities 241 defined thereon. The base 22 has corresponding cams 227 for locking with the cross-shaped cavities 241. Each pair of the terminals 21 and the grounding contacts 247, respectively, are located one next to the other.

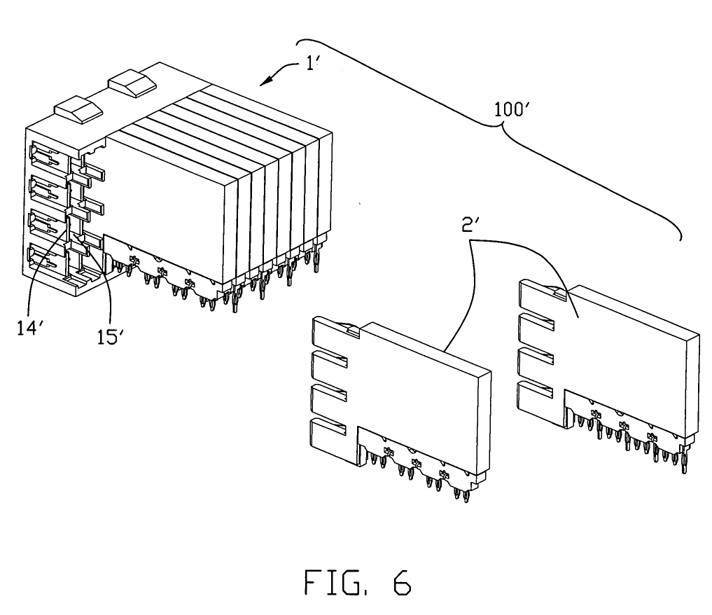

Referring to FIGS. 5 and 6, in assembling of the electrical connector 100, firstly, the terminals 21 are mounted in the base 22 during injecting molding. The cover 23 is assembled to the base 22 via the engagement of the posts 234, 235 of the floor 233 and corresponding holes 226 of the base 22. Secondly, the shielding plate 24 is mounted to the base 22 by the engagement of the cavities 241 and the cams 227 of the base 22. Thirdly, the terminal modules 2 are inserted in the insulative housing 10 in a back-to-front direction, with the contacting portions 211 of the terminals 23 and the grounding contacts 247 of the shielding plate 24 received in the passageways 15 of the insulative housing 1.

FIGS. 6-8 illustrate a second preferred embodiment of the present invention. In this embodiment, an electrical connector 100′ is mounted on a printed circuit board (not shown) comprises an insulative housing 1′ and a plurality of terminal modules 2′ mounted to the insulative housing 1′.

The insulative housing 1′ has a front wall (not labeled), a rear wall 14′, four groups of passageways 15′ profiled one above the other and extending through the rear wall 14′ and front wall.

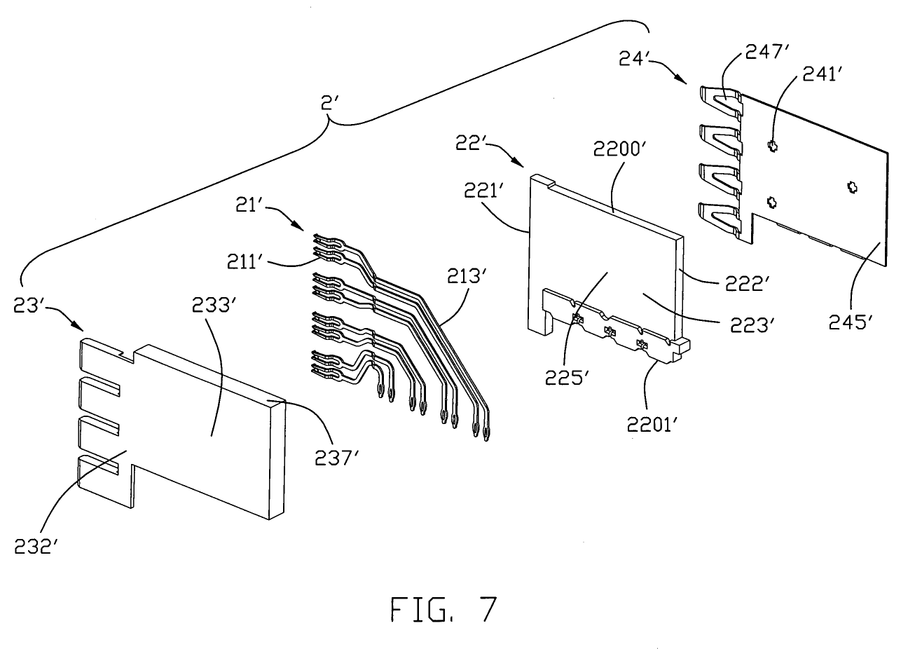

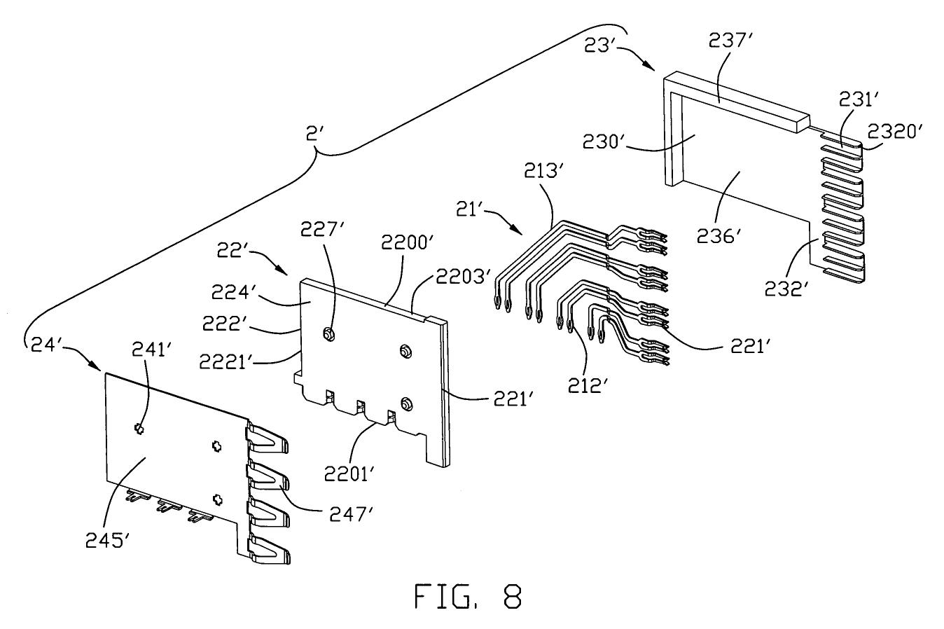

Referring to FIGS. 7-8, the terminal modules 2′ comprises a base 22′ having a first surface 223′ and a second surface 224′ opposite to the first surface 223′, a plurality of terminals 21′ mounted to the passageways 15′ of the insulative housing 1′ and a shielding plate 23′ assembled to the second surface 224′ of the base 22′. The first surface 223′ has a recess portion 225′ defined thereon for engaging with the terminals 21′. The base 22′ is of rectangular configuration and has a top face 2200′ defining an indentation 2203′, a bottom face 2201′ and a pair of side faces 221′, 222′. One of the side face 222′, has a depression 2221′ defined thereon

The plurality of terminals 21′ assembled to the base 22′ during injecting molding. Each terminal 21′ comprises a contacting portion 211′ exposed from a first side face 221′ of the base 22′, a tail 212′ exposed from the bottom face 2201′ of the base 22′ and connected to the printed circuit board, and an intermediate portion 213′ connecting the contacting portion 211′ and the tail 212′ and received in the recess portion 225′.

The terminal module 2′ further comprises a cover 23′ mounted to the recess portion 225′ of the base 22′. The cover 23 comprises a floor 233′ cooperating with recess portion 225′ to fix the intermediate portion 213′ of terminals 21′ within the recess portion 225′, and a tongue section 232′ extending from the floor 233′. The floor 233′ of the cover 23′ comprises a pair of protruding beams 237′ disposed on lateral and upper portions thereof and locating on the depression 2221′ and indentation 2203′ of the base 22′ for fixing the base 22′ to the cover 23′. The tongue section 232′ comprises a plurality blades 2320′ protruding therefrom to thereby form a plurality of terminal spaces 231′ between the pair of blades 2320′ for retaining the contacting portion 221′ of the terminal 22′.

The shielding plate 24′ is punched by a metal strip and has a intermediate plate 245′ and a plurality of grounding contacts 247′ extending from the intermediate plate 245′ and exposed from the first side face 221′ of the base 22′. The grounding contact 247′ has a V-shaped and inserts to the passageway 15′ of the insulative housing 1′. The intermediate plate 245′ comprises a plurality of cross-shaped cavities 241′ defined thereon. The base 22′ has corresponding cams 227′ for locking with the cross-shaped cavities 241′. Each pair of the terminals 21′ and the grounding contacts 247′, respectively, are located one next to the other.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electrical connector mounted on a printed circuit board, comprising:
an insulative housing comprising a plurality of passageways;
a plurality of terminal modules mounted to the insulative housing, each terminal module comprising:
a base defining a recess portion on a side face thereof;
a shielding plate mounted to another side surface of the base; and
a plurality of terminals assembled to the base, each terminal comprising a contacting portion exposed from a forward edge of the base, a tail exposed from a bottom edge of the base for connecting to the printed circuit board, and an intermediate portion connecting the contacting portion and the tail; and
a cover assembled with the base and sandwiching therebetween the terminals, said cover comprising a floor covering at least the intermediate portions of the terminals, and a tongue section extending from the floor and defining a plurality of terminal spaces for receiving the contacting portions of the terminals.

2. The electrical connector as claimed in claim 1, wherein said tongue section of the cover defines a plurality of slots separating said terminal spaces into pairs.

3. The electrical connector as claimed in claim 1, wherein said floor of the cover comprises a plurality of posts formed thereon, and the base comprises corresponding holes defined thereon for engaging with the posts of the floor.

4. The electrical connector as claimed in claim 1, wherein said base comprises a top face defining an indentation, a bottom face and a pair of opposite side faces, one of the side faces having a depression defined thereon.

5. The electrical connector as claimed in claim 4, wherein said floor of the cover comprises a pair of protruding beams disposed on lateral and upper portions and engaging with the depression of the side face and the indention of the top face of the base for fixing the base to the cover.

6. The electrical connector as claimed in claim 1, wherein said shielding plate comprises a plurality of cavities defined thereon, and wherein the base has corresponding cams for mating with the cavities.

7. The electrical connector as claimed in claim 1, wherein said shielding plate comprises a forward end and a bottom end perpendicular to said forward end.

8. The electrical connector as claimed in claim 7, wherein said forward end of said shielding plate comprises at least one contact extending along with the contact portions of the terminals.

9. The electrical connector as claimed in claim 8, wherein said grounding contact is V-shaped.

10. The electrical connector as claimed in claim 7, wherein said bottom end of said shielding plate comprises at least one ground tab extending toward and received in an adjacent base.

11. The electrical connector as claimed in claim 1, wherein said cover defines a planar side surface and an opposite side surface with said terminal spaces defined thereon.

12. An electrical connector comprising:
a plurality of terminal modules stacked with one another;
each of said terminal modules including:
an insulative base defining opposite inward and outward surfaces thereon;
a metallic shielding plate located upon the outward surface;
a plurality of terminals associatively attached to the base and spaced from the outward surface, each of said terminals defining a mating section and a mounting section extending in two different directions perpendicular to each other with a connection section therebetween; and
an insulative cover having opposite inward outward faces with said inward face positioning upon the inward surface and defining a terminal space to receive the corresponding mating sections of the terminals; wherein the shielding plate of the terminal module intimately engages the outward face of the neighboring terminal module; wherein said cover extends over essentially most portions of the connection sections.

13. The electrical connector as claimed in claim 12, wherein in each terminal module, the base and the cover commonly define a hybrid thickness under condition that each of said base and said cover has a first portion dimensioned essentially equal to said thickness, and a second portion which requires to cooperate with a intimate corresponding portion of the other aside to be commonly dimensioned essentially equal to said thickness.

14. The electrical connector as claimed in claim 13, wherein said second portion is located around the connection section rather than the mating section and the mounting section.

15. The electrical connector as claimed in claim 14, wherein the base defines an interior step in compliance with an exterior contour of the cover for compliantly receiving said second portion.
